(19) United States
(12) Patent Application Publication
(10) Pub. No.: US 2009/0274904 A1
(43) Pub. Date: Nov. 5, 2009

(54) ADHESION MEANS WITH HIGH IMPACT RESISTANCE

(75) Inventors: Bernhard Müssig, Seevetal (DE); Nicole Behrens, Munchen (DE); Werner Kluge-Paletta, Buchholz (DE); Petra Lohmann, Heidenau (DE)

Correspondence Address: NORRIS, MCLAUGHLIN & MARCUS, 875 THIRD AVE, 18TH FLOOR, NEW YORK, NY, 10022, US

(73) Assignee: TESA SE, Hamburg (DE)

(21) Appl. No.: 12/514,606

(22) PCT Filed: Nov. 8, 2007
(86) PCT No.: PCT/EP07/62046

§ 371 Date: May 13, 2009

(30) Foreign Application Priority Data
Nov. 24, 2006 (DE) 102006055961.4

(51) Int. Cl. B32B 5/00; B32B 7/04

(52) U.S. Cl. 428/343; 428/337; 428/355 AC; 428/355 N; 428/355 R

(57) ABSTRACT

The invention relates to an adhesion means with a backing layer and with at least one adhesion mass layer arranged thereon wherein the backing layer encompasses at least one layer composed of oriented polypropylene, and wherein the layer has cavities whose dimension respectively in the main directions of the plane of extension (x direction and y direction) amounts to many times its dimension in a direction orthogonal to said plane (z direction).

The invention relates to an adhesive bonding means for increasing the impact resistance of an adhesive bond, and to its use.

For the permanent adhesive bonding of, for example, mobile telephone screens, use has been made to date of double-sidedly pressure-sensitively adhesive bonding means with carriers based on polyester or on foamed films. Prior to adhesive bonding, these pressure-sensitive adhesive bonding means are diecut in accordance with the aesthetic and technical requirements, and must therefore feature good diecutability. It is desirable, furthermore, for the pressure-sensitive adhesive bonding means used to possess effective shock absorption and not to lose this absorption behaviour even at low temperatures down to at least −20° C. The advantage resulting for the user from effective shock absorption is that the adhesive bond holds securely even when the mobile telephone or other device suffers a fall from a relatively great height. (The terms impact and shock resistance and also impact and shock absorption are each used synonymously in the text below).

At the present time requirements of this kind can be achieved through the use of a foam as carrier material. Use may be made, for example, of foamed polyethylene or foamed polypropylene (U.S. Pat. No. 5,264,278). The improvement in impact resistance can be attributed to the compressibility of the foam's cells. Particularly at low temperatures, moreover, the use of a polymer having a very low glass transition temperature is typical for improving the low-temperature impact resistance. Embrittlement of the polymer at low temperature starts at much lower temperatures in the case, for example, of polyethylenes, owing to the glass transition temperature, than in the case of polyester or polypropylene, where the capacity to absorb the cold shock falls significantly as a result. Furthermore, only polymer chains present in amorphous form possess a glass transition temperature above which the chains become mobile. This mobility on the part of the chains makes a critical contribution to absorbing the energy of the cold shock. Crystalline polymer chains exhibit this mobility only when the crystalline structure is broken up, in the region of the melting temperature. Amorphous polymers therefore have better low-temperature impact resistance than polymers having a high crystalline fraction, of the kind which can be produced by orientation, for example. A largely amorphous polyethylene or polypropylene film, however, has much poorer diecutability than a polymer film having a high crystalline fraction, such as an oriented polyester carrier material, for example, on account of the mechanical properties of the polyethylene or polypropylene foam, more particularly its extensibility. Orienting polymer films increases the crystalline fraction of the polymer and results in increased brittleness and reduced residual extensibility in comparison to unoriented films of the same material. Examples of films oriented biaxially (i.e. in directions x and y) are PET-BO and PP-BO films. Both carrier materials are readily diecutable on account of their mechanical properties. A carrier film which exhibits not only good impact resistance but also good diecutability has not been identified to date.

The object on which the invention is based, therefore, is that of offering an adhesive tape which, within an adhesive bond, exhibits enhanced impact resistance, where at the same time, in particular, the adhesive bonding agent should attain optimum diecutability.

According to the invention, the object is achieved, surprisingly, by means of a single- or double-sidedly adhesive bonding means with a carrier layer based on an oriented polypropylene, more particularly based on a biaxially oriented polypropylene (PP-BO) containing cavities. PP-BO refers generally to biaxially oriented polypropylene.

The invention accordingly provides an adhesive bonding means with at least one carrier layer and at least one adhesive layer disposed thereon, characterized in that the carrier layer comprises at least one oriented polypropylene layer characterized in that it has cavities whose extent in each of the major directions of the orientation plane (x and y directions) is a multiple of its extent in the direction orthogonal to this plane (z direction).

The major directions in the orientation plane are the directions through which the orientation plane is stretched.

The general expression “adhesive bonding means” embraces, for the purposes of this invention, all filmlike structures, such as two-dimensionally extended films or film sections, tapes with extended length and limited width, tape sections, diecuts, labels and the like.

Used advantageously according to the invention are adhesive bonding means having a carrier layer of cavitated PP-BO (biaxially oriented polypropylene) with densities of less than 0.85 g/cm³, more particularly 0.70 g/cm³. Films of this kind are described in particular in U.S. Pat. No. 4,377,616, WO 8900105 A and in WO 03033574 A; the disclosure content of those specifications is incorporated in its entirety into the disclosure content of the present specification. As described in the above-cited specifications, the cavities in the PP-BO film are produced by coextrusion with particles and subsequent coaxial orientation.

In terms of process engineering, the carrier layer of the invention can be produced in a variety of ways. Particularly preferred methods are those in which the cavities are initiated using particles which in terms of melting point and in terms of glass transition point are situated above the melting and glass transition points of the polypropylene. The particles are incompatible with the polypropylene matrix in the sense that the particles and the matrix polymer are always present as two separate phases. Suitable materials which can be used in particle form are, for example, polyamides or nylon, polyesters (such as polybutylene terephthalate, for example), cycloolefin copolymers, crosslinked polystyrene, calcium carbonate, titanium dioxide, glass and metallic pigments.

In one embodiment of the adhesive bonding means of the invention, accordingly, the oriented polypropylene layer comprises particles incompatible with the polypropylene.

In accordance with the invention particular advantage is attached to using films which are obtainable as follows:

According to U.S. Pat. No. 4,377,616, spherical particles (having an average ratio of the diameters in directions x, y and z of 1) with diameters of 0.1 to 10 μm are used. Up to 20% by weight of these particles is added to the polymer. The orientation of the film takes place sequentially at temperatures between 100 and 160° C., the first orienting operation, in machine direction, taking place at a lower temperature than the second, in cross direction. The draw ratio in both the machine direction and the cross direction is between 4:1 and 8:1.

A similar method is utilized by WO 8900105 A. This method uses polypropylenes having a melt flow index of between 1.5 and 18 (in accordance with ASTM D1238). Moreover, the polypropylenes used have a polydispersity of between 3.0 and 5.5 (according to a method of Zeichner and Patel: “A comprehensive evaluation of polymer melt rheology”, Proceedings of 2nd World Congress of Chem. Eng., Vol. 6, p. 333, Montreal, 1981). The size of the particles is 1-10 μm, and they are present in the polymer at 1%-30% by weight. The draw ratio is between 4:1 and 8:1 in machine direction and between 8:1 and 13:1 in cross direction. Films are obtained which have densities of less than 0.7 g/cm³

In a contradistinction to the sequential orientation, WO 03033574 A describes a process in which a cavitated film is produced by a simultaneous drawing method. In the simultaneous drawing method, orientation takes place in the machine and cross directions simultaneously. In this process it is possible to use spherical particles having average diameters of between 3 and 10 μm, which should not, however, include any particles having diameters above 12 μm. An alternative possibility is to use elongated particles (with an average ratio of the diameters in directions x and y of at least 2). Elongated particles are used with average diameters of more than 3 μm. Spherical or elongated particles can be added to the polymer at 5%-40% by weight. The drawing temperature is between 150 and 160° C.; the draw ratio in machine and cross directions is 8:1. This production process produces densities of less than 0.85 g/cm³.

In one advantageous embodiment of the adhesive bonding means the carrier layer is a multi-layer film which includes at least one layer of cavitated polypropylene, more particularly a three-layer or five-layer film.

With advantage it is possible to use multi-layer films in which there are one or more layers of non-cavitated polymer on both sides of the layer of cavitated PP-BO. The non-cavitated layer may be composed of homo-, co- or terpolymer of polyethylene (PE), polypropylene (PP) and/or polybutylene, very preferably of a PP homopolymer. Owing to the optimum compatibility and resultant effective cohesion of the assembly of a plurality of layers, multi-layer films in which all of the layers are composed of biaxially oriented polypropylene are particularly suitable for use as impact-resistant adhesive bonding means.

The production of the cavities during the orientation in x and y directions generates voids in the layer, it being true for the multiplicity of these voids that their extent in x and y directions is substantially greater than the extent in the z direction, i.e. at right angles to the drawing directions. The extent of the cavities in the z direction typically corresponds approximately to the diameter of the particle that produced this cavity. The extent in the x and y directions is generally a multiple of this diameter and is dependent on the polymer used, the size of the particles, and the process. The extent and number of the cavities have a direct influence on the density of the film.

A further advantageous embodiment of the invention features a multi-layer film which has been produced by coextrusion and in which the cavitated polypropylene layer is located in the core. In contrast to a multi-layer film produced by laminating two or more films, a multi-layer film in the case of coextrusion is obtained during the actual film production step.

Very preferably, in the oriented polypropylene layer, the adhesive bonding means of the invention has particles which possess an average diameter of greater than 1 μm, preferably of greater than 2 μm, and not more than 12 μm.

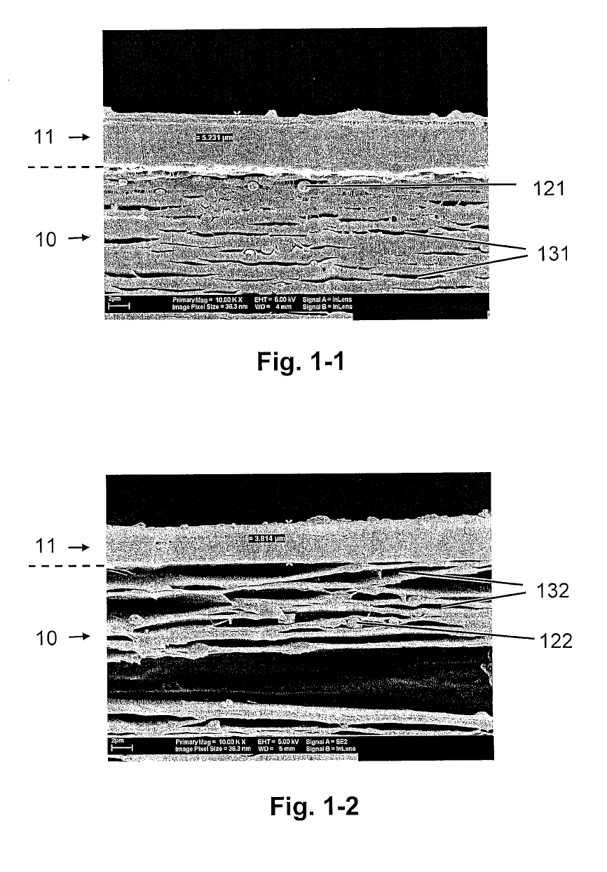

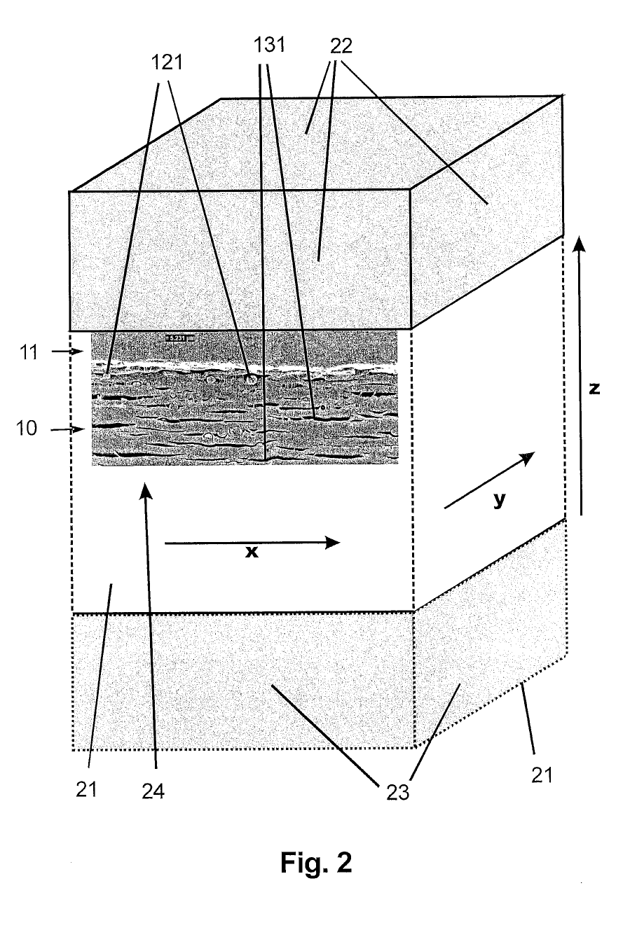

FIGS. 1 and 2 serve for illustration of the layer construction of the films, without any intention that unnecessary restrictions should be imposed by the examples shown.

Shown by way of example in FIG. 1 are two cavitated multi-layer PP-BO films from different production processes in cross section (cross-sectional images of films with small particles/cavities [FIG. 1-1, Label-Lyte LH247 from ExxonMobil Chemical] and larger particles/cavities [FIG. 1-2, EUH 90 from Treofan]).

The cavitated polypropylene layer (10) is in each case located in the core; the extracts show a top cut of the film, comprising a section of one or more non-cavitated upper layers (11) and also a section of the cavitated layer (10).

Common to both films is a multiplicity of cavities which possess a large extent in the x and y directions. The polymer between the cavities is similar to a layer structure, with an extent of the layers in the x and y directions. Since there is no pure layer structure of mutually independent layers, but instead there are “quasi-layers”, which are variable in their extent and thickness and are connected to one another, the film has cohesion in the z direction. In the cross section of the film from ExxonMobil Chemical in FIG. 1-1, filler particles (121) and cavities (131) are clearly evident. The size and number of the cavities determine the film density of 0.72 g/cm³. In FIG. 1-2 as well particles (122) and cavities (132) can be seen. This film was produced by Treofan. The cavities (132) in FIG. 1-2, however, have a very much greater extent than those (131) of the film in FIG. 1-1. In accordance with the larger cavities in 1-2, the density is reduced as compared with the film in 1-1. It is only 0.55 g/cm³.

Particularly suitable for the inventive application are films having densities below 0.85 g/cm³ and in particular having cavities which have been produced by filler particles of more than 1 μm in diameter; preferred films are those having densities less than 0.70 g/cm³ and greater than 0.30 g/cm³, and in particular having cavities produced by filler particles with a diameter of more than 2 μm. The shock absorbency of the film and hence the impact resistance of the adhesive bond goes up as the size of the cavities increases, i.e. in particular as the extent of the cavities increases in the x and y directions. Consequently, in particular, films having densities of less than 0.85 g/cm³, in particular less than 0.70 g/cm³, are suitable as carrier film in the adhesive bonding means of the invention. The film shown in FIG. 1-2, in accordance with the larger cavities, also possesses better impact resistance than the film in FIG. 1-1 (cf. Example 1 and Example 3).

FIG. 2 shows—diagrammatically and not true to scale—a section from an adhesive bonding means of the invention with a carrier layer (21) of oriented polypropylene and with at least one adhesive layer (22) disposed thereon. A second adhesive layer (23) may be present, optionally, so that both single-sided and double-sided adhesive bonding means are embraced by the invention. The coordinate vectors show the position of the directions x and y (major directions of the orientation plane) and also z (orthogonal to the orientation plane). The embedded version of FIG. 1-1 shows how the sections shown in FIGS. 1-1 and 1-2 are situated within this section of adhesive bonding means (24). The positional FIG. 10 shows the cavitated film region, the positional FIG. 11 the non-cavitated film region of the multi-layer film (in the same way as in FIG. 1-1).

In both the longitudinal direction and the transverse direction, the values of the tensile elongation ought advantageously to be more than 10 N/mm², and those of the thickness of the film ought to be more than 30 μm, preferably more than 50 μm.

Surprisingly to the skilled person, in spite of the increased glass transition temperature as compared with polyethylene and the increased crystalline polymer fraction as compared with polypropylene, these films feature good low-temperature impact resistance. In particular, films with cavities having a large extent in the x and y directions display advantageous impact resistance, since, as a result of the consequent local layer structure, the shock can be transmitted more effectively in these directions than in the z direction. The increased rigidity in relation to a polyethylene film or an unoriented polypropylene film, moreover, results in an improvement in diecutability.

The adhesive layer disposed on the carrier layer is preferably a layer of pressure-sensitive adhesive. Also possible alternatively, of course, is a coating with heat-activable film or reactive adhesive. For double-sided adhesive bonding means, one or both of the layers may be pressure-sensitively adhesive, heat-activable or reactively adhesive. For the adhesive tape application, the film is coated on one or both sides with the preferred pressure-sensitive adhesive, in the form of a solution or dispersion or in 100% form (melt form, for example), or coated by coextrusion with the film. The adhesive layer or layers can be crosslinked by heat or high-energy beams, and where necessary can be lined with release film or release paper. Particularly advantageous adhesive bonding means are those in which the adhesive layer, more particularly the pressure-sensitive adhesive layer, is based on acrylate, silicone, polyurethane and rubber (or, in the case of double-sided adhesives, those in which both adhesive layers, more particularly pressure-sensitive adhesive layers, are based on the aforementioned compounds).

In order to optimize the properties it is possible with preference for the self-adhesive composition employed to have been blended with one or more additives such as tackifiers (resins), plasticizers, fillers, pigments, UV absorbers, light stabilizers, ageing inhibitors, crosslinking agents, crosslinking promoters or elastomers.

Physical pretreatment of the carrier film layer for the purpose of improving the adhesion, by flame, plasma or corona treatment, is advantageous.

If necessary, application of the pressure-sensitive adhesive layer may be preceded by application of a primer layer, in particular solventlessly, such as by coextrusion, for example, so that there is a primer layer located between a carrier film layer and a pressure-sensitive adhesive layer.

In a further embodiment, the carrier material is provided on both sides with a coating of pressure-sensitive adhesive. The amount of the adhesive layer is preferably in each case 10 to 120 g/m², preferably 25 to 100 g/m² (application rate after removal, if necessary, of water or solvent). The numerical values also correspond approximately to the thickness in μm; in accordance with the invention, therefore, it is advantageous to select pressure-sensitive adhesive coat thicknesses of 10 to 120 μm, more particularly of 25 to 100 μm.

In the case of an adhesive coating, the data given here for thickness and for thickness-dependent mechanical properties of the carrier material relate exclusively to the PP-BO-containing layer of the pressure-sensitive adhesive bonding means, without taking account of the adhesive layer or of other layers which are advantageous in connection with adhesive layers.

The pressure-sensitive adhesive to be used for the single-side or both-sides treatment of the carrier material may be selected in particular from the group of acrylate, silicone, polyurethane or rubber adhesives. Particular preference is given here to the use of pressure-sensitive polyacrylate adhesives which comprise a polymer which in relation to the polymer comprises 79% to 100% by weight of acrylic esters and/or methacrylic esters and/or the associated free acids with the formula CH₂═C(R³)(COOR⁴), where R³ is H and/or CH₃ and R⁴ is H and/or alkyl chains having 1 to 30 C atoms; and 0 to 30% by weight of olefinically unsaturated monomers with functional groups, the weight figures being based on the polymer.

Single-sidedly pressure-sensitive adhesive bonding means as well can be produced on the basis of a PP-BO carrier with cavities. In this embodiment, treatment with an anti-adhesive agent is possible on the side of the carrier that is not coated with adhesive.

Also embraced by the invention, and as described as being in accordance with the invention in the context of this specification, are adhesive bonding means which additionally, in the direct or indirect vicinity of the carrier layer, additionally have at least one functional layer. Examples of functional layers are layers of coloured coating material, of primer or of anti-adhesive agent.

Pressure-sensitive adhesive bonding means of the invention have particular importance in the electronics industry. There they are used, for example, in the form of diecuts to mount screens in mobile telephones. Further applications can be found in particular in portable devices, such as cameras, palmtops, laptops, portable audio devices and, more generally, any adhesive bonds which are or may be subject to shock loads. Since for mobile items in particular there is always the possibility of a drop, it is here that the use of an impact-resistant bond is particularly attractive. The probability of the bond withstanding a drop undamaged is very much greater when using the adhesive bonding means of the invention than in the case of conventional adhesiving bonding means which do not have a heightened impact resistance.

The invention further provides, accordingly, for the use of an adhesive bonding means of the invention for increasing the impact resistance of an adhesive bond with one or more elements, more particularly the low-temperature impact resistance at temperatures greater than −40° C.

### Test Methods

Unless indicated otherwise, the measurements are carried out under test conditions of 23±1° C. and 50±5% relative humidity.

The tensile extension of the adhesive tape is determined (where possible) on test strips 15 mm wide and 150 cm long, clamped-in length 100 mm, in accordance with DIN EN ISO 527-3/2/300, with a testing speed of 300 mm/min.

The bond strengths are determined (where possible) at a peel angle of 180° in accordance with AFERA 4001 on test strips 20 mm wide. This is done using steel plates according to the AFERA standard as the test substrate.

The thickness is determined in accordance with DIN 53370, with the gauge being planar (not curved). In the case of textured films, however, the thickness prior to embossing is used. This can also be done retrospectively via the basis weight (determined in accordance with DIN 53352) with conversion using the density. The depth of embossing is the difference between the thicknesses with and without embossing.

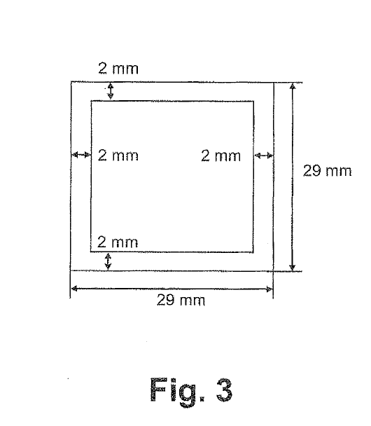

The impact resistance is determined by a performance drop test at 23° C. and −20° C. In this test, a steel ball with a mass of 13.5 g falls from defined heights onto an adhesive bond composed of steel plate, double-sided adhesive tape diecut according to FIG. 3 (FIG. 3 shows the dimensions of the diecut used in the drop test), and ABS frame. The adhesive bond lies horizontally with the ABS frame on a mount; the steel plate hangs free towards the bottom. Because the ABS frame and the diecut have sufficiently large openings, the steel ball strikes the steel plate and in that way exerts an impact load on the adhesive bond. The height from which the steel ball falls on the adhesive bond is varied until the adhesive bond is destroyed by the impact load. The figure reported is the maximum possible drop height h of the steel ball without disruption of the adhesive bond.

The examples which follow are intended to illustrate the invention without imposing any restriction on its scope.

### EXAMPLES

### Preparation of the Polyacrylate

A 2 l glass reactor conventional for free-radical addition polymerizations was charged with 40 g of acrylic acid, 360 g of 2-ethylhexyl acrylate and 133 g of acetone/isopropanol (96:4). After nitrogen gas had been passed through the reactor for 45 minutes, the reactor was heated to 58° C. with stirring and 0.2 g of azoisobutyronitrile (AIBN, Vazo 64™, DuPont) was added. Then the external heating bath was heated to 75° C. and the reaction was carried out constantly at this external temperature. After a reaction time of 1 h a further 0.2 g of AIBN was added. After 4 h and 8 h, dilution was carried out with in each case 100 g of acetone/isopropanol (96:4) mixture. For the reduction of the residual initiators, after 8 h and after 10 h, in each case 0.6 g of bis(4-tert-butylcyclohexanyl)peroxydicarbonate (Perkadox 16™, Akzo Nobel) was added. After a reaction time of 24 h the reaction was discontinued and the mixture cooled to room temperature.

The polyacrylate was subsequently blended with 0.4% by weight of aluminium(III) acetylacetonate (as a 3% strength solution in isopropanol), diluted to a solids content of 30% with isopropanol, and then coated from solution onto release paper and PP film, respectively. After drying for 20 minutes at 90° C., the application rate was 50 g/m².

Prior to coating, the carrier film was corona-treated on both sides. The adhesive was applied to both sides of the cavitated carrier material by lamination of coated release paper. The release paper was then removed from one side again, and the adhesive tape was wound to form log rolls.

Slitting took place by cutting log rolls with a running length of 66 m by means of rotating round blades or, alternatively, by cutting log rolls using a fixed blade (straight knife). Then diecuts were produced.

### Comparative Example 1

The foamed polypropylene film PP-Soft 200 from Nowofol of Siegsdorf, Del., was coated with acrylate adhesive. The carrier film is unoriented and has a thickness of 200 μm and a density of 0.65 g/cm³.

### Comparative Example 2

The carrier film used was the film OPR 40 from Pao Yan Tsae Yih of Taoyuan Hsien, Taiwan. This film is a highly transparent PP-BO film without cavities, and has a thickness of 40 μm. The film has a density of 0.9 g/cm³.

### Inventive Example 1

For the production of the example, the film EUH 90 from Treofan of Raunheim, Del., was coated with the specified acrylate adhesive. The film has a five-layer construction with a middle layer of cavitated PP-BO. This middle layer, with a thickness of 80 μm, represents the major component of the film, whose total thickness is 90 μm. The cavities in the biaxially oriented PP film are produced by coextruding the polymer with filler particles and then orienting it. The filler particles have diameters between 1.5 and 10 μm. The film has a density of 0.55 g/cm³.

TABLE 1
Comparison of properties

| | Film | Film | Particle | Average extent | Tensile | Tensile |
|---|---|---|---|---|---|---|
| | thickness | density | diameter | of voids in z | strength | strength |
| | [μm] | [g/cm³] | [μm] | direction [μm] | MD* [N/mm²] | CD* [N/mm²] |
| Comparative | 200 | 0.65 | N/A | not tested | 11 | 6 |
| Example 1 | | | | | | |
| Comparative | 40 | 0.91 | N/A | N/A | not tested | not tested |
| Example 2 | | | | | | |
| Inventive | 90 | 0.55 | 1.5-10 | 1.2 | 100 | 55 |
| Example 1 | | | | | | |

| | | | | Drop test, 25° | Drop test, −20° |
|---|---|---|---|---|---|
| | Breaking | Breaking | Bond | C., max. drop | C., max. drop |
| | extension | extension | strength | height h | height h |
| | MD* [%] | CD* [%] | steel [N/cm] | [cm] | [cm] |
| Comparative | 477 | 177 | 20 | not tested | 7 |
| Example 1 | | | | | |
| Comparative | not tested | not tested | 11.5 | 50 | 2 |
| Example 2 | | | | | |
| Inventive | 14 | 119 | 10 | 90 | 50 |
| Example 1 | | | | | |

*MD in machine direction; CD in cross direction (transversely to the machine direction)

Particularly meaningful with regard to the impact resistance are the results of the drop test. The drop test on bonds of Inventive Example 1 shows that the maximum drop height h is well above those for the comparative examples. For instance, for Inventive Example 1 at room temperature, the bond is not destroyed until the drop height exceeds 90 cm, whereas the comparative examples remain intact only up to a height at most of 50 cm. The failure of the bond of Inventive Example 1 at room temperature can be attributed, moreover, to the failure of the connection between non-cavitated polymer layer and cavitated PP-BO layer in the multi-layer film. In the case of better cohesion between the two layers, the impact resistance at room temperature would certainly have been even higher. At −20° C., the maximum destruction-free drop height is still 50 cm, anyway; the comparative examples attaining a maximum of 7 cm. The cavities present in the film from Inventive Example 1 result in a markedly improved impact resistance at room temperature and also at low temperature. Foamed polypropylene film (Comparative Example 1) or non-cavitated PP-BO (Comparative Example 2) come out very much worse.

### Inventive Example 2

The carrier film used was the film Propafilm TB22A140 from Innovia of Wigton, UK. It has a nominal thickness of 140 μm and exhibits a multi-layer construction. The middle layer has a thickness of 90 μm and is composed of cavitated PP-BO. The filler particles used to generate the voids in the PP-BO consist of CaCO₃ and have a diameter of up to 10 μm. The film is coloured white using titanium dioxide. The film has a density of 0.69 g/cm³.

TABLE 2
Comparison of properties

| | Film | Film | Particle | Average extent | Tensile | Tensile |
|---|---|---|---|---|---|---|
| | thickness | density | diameter | of voids in z | strength | strength |
| | [μm] | [g/cm³] | [μm] | direction [μm] | MD* [N/mm²] | CD* [N/mm²] |
| Comparative | 200 | 0.65 | N/A | not tested | 11 | 6 |
| Example 1 | | | | | | |
| Comparative | 40 | 0.91 | N/A | N/A | not tested | not tested |
| Example 2 | | | | | | |
| Inventive | 140 | 0.69 | ≦10 | 1.0 | 78 | 94 |
| Example 2 | | | | | | |

| | | | | Drop test, 25° | Drop test, −20° |
|---|---|---|---|---|---|
| | Breaking | Breaking | Bond | C., max. drop | C., max. drop |
| | extension | extension | strength | height h | height h |
| | MD* [%] | CD* [%] | steel [N/cm] | [cm] | [cm] |
| Comparative | 477 | 177 | 20 | not tested | 7 |
| Example 1 | | | | | |
| Comparative | not tested | not tested | 11.5 | 50 | 2 |
| Example 2 | | | | | |
| Inventive | 48 | 62 | 11.4 | 180 | 20 |
| Example 2 | | | | | |

*MD in machine direction; CD in cross direction (transversely to the machine direction)

For Inventive Example 2 as well, the results of the drop test are well above those for the comparative examples. Since the density of the film from Inventive Example 2 is somewhat higher than that of the film from Inventive Example 1 (0.69 as compared with 0.55 g/cm³), the figure achieved at −20° C. is somewhat lower here than the figure from Inventive Example 1. The very good figure in the drop test at room temperature is achieved because the cohesion of the layers in the multi-layer film is better for Inventive Example 2 than for Inventive Example 1. In Inventive Example 2, all of the layers consist of polypropylene, which has the effect of a very good anchorage of the outer layers on the cavitated layer. Of particular interest for Inventive Example 2 is the comparison with the foamed polypropylene film (Comparative Example 1), since the latter has a similar density. In the drop test, the foamed PP film comes out very much worse than the cavitated film. This comparison illustrates the advantageous form of the cavities with an extent in the x and y directions that is a multiple of the extent in the z direction.

### Inventive Example 3

The film used for coating was Label-Lyte LH247 from ExxonMobil Chemical of Luxemburg, L. With a thickness of 70 μm, the film possesses a three-layer construction. The middle layer is composed of cavitated PP-BO with a thickness of 60 μm. The filler particles used to generate the cavities in the PP-BO have a diameter of 1-2 μm. The cavities are therefore much smaller than in the case of the films of Inventive Examples 1 and 2. This film has a density of 0.72 g/cm³.

TABLE 3
Comparison of properties

| | Film | Film | Particle | Average extent | Tensile | Tensile |
|---|---|---|---|---|---|---|
| | thickness | density | diameter | of voids in z | strength | strength |
| | [μm] | [g/cm³] | [μm] | direction [μm] | MD* [N/mm²] | CD* [N/mm²] |
| Comparative | 200 | 0.65 | N/A | not tested | 11 | 6 |
| Example 1 | | | | | | |
| Comparative | 40 | 0.91 | N/A | N/A | not tested | not tested |
| Example 2 | | | | | | |
| Inventive | 70 | 0.72 | 1-2 | 0.4 | 134 | 89 |
| Example 3 | | | | | | |

| | | | | Drop test, 25° | Drop test, −20° |
|---|---|---|---|---|---|
| | Breaking | Breaking | Bond | C., max. drop | C., max. drop |
| | extension | extension | strength | height h | height h |
| | MD* [%] | CD* [%] | steel [N/cm] | [cm] | [cm] |
| Comparative | 477 | 177 | 20 | not tested | 7 |
| Example 1 | | | | | |
| Comparative | not tested | not tested | 11.5 | 50 | 2 |
| Example 2 | | | | | |
| Inventive | 21 | 145 | 14.4 | not tested | 7 |
| Example 3 | | | | | |

*MD in machine direction; CD in cross direction (transversely to the machine direction)

In terms of impact resistance, the ExxonMobil Chemical film in Inventive Example 3 comes out similarly to the foamed polypropylene film from Comparative Example 1. Nevertheless it is preferred over the foamed film on account of its better diecutability. With a density of 0.72 g/cm³, the film of Inventive Example 3 possesses the highest density of the foamed or cavitated films investigated. Particularly preferred in the context of the invention, therefore, are films having densities of less than 0.70 g/cm³, since they come out very much better in terms of impact resistance than do foamed films.

1. Adhesive bonding means, comprising a carrier layer and at least one adhesive layer disposed thereon,
wherein the carrier layer comprises at least one oriented polypropylene layer and wherein the carrier layer has cavities whose extent in each of a x direction and a y direction of an orientation plane is a multiple of its extent in a direction orthogonal to said plane in z-direction.

2. Adhesive bonding means according to claim 1, wherein the at least one oriented polypropylene layer comprises particles incompatible with the polypropylene.

3. Adhesive bonding means according to claim 1, wherein the polypropylene of the carrier layer is biaxially oriented.

4. Adhesive bonding means according to claim 1, wherein the carrier layer is composed of a multi-layer film, including at least one layer of cavitated polypropylene.

5. Adhesive bonding means according to claim 4, wherein the multi-layer film is coextruded, the polypropylene layer being disposed in a core.

6. Adhesive bonding means according to claim 1, wherein at least one layer adjacent to the polypropylene layer is composed of non-cavitated homo-, co- or terpolymer of polyethylene, polypropylene and/or polybutylene.

7. Adhesive bonding means according to claim 1 wherein the density of the carrier layer is less than 0.85 g/cm3.

8. Adhesive bonding means according to claim 2, wherein the particles possess an average diameter of greater than 1 pm.

9. Adhesive bonding means according to claim 1, wherein it is a pressure-sensitive adhesive bonding means.

10. Adhesive bonding means according to claim 1, wherein the adhesive layer is formed from the group consisting of acrylate adhesives, silicone adhesives, polyurethane adhesives and rubber adhesives.

11. Adhesive bonding means according to claim 10, the pressure-sensitive adhesive layer being composed of a polyacrylate pressure-sensitive adhesive and comprising a polymer which in relation to the polymer contains
(b1) 79% to 100% by weight of acrylic esters and/or methacrylic esters and/or the associated free acids, with the formula CH2=C(R3)(COOR4), R3 being H and/or CH3 and R4 being H and/or alkyl chains having 1 to 30 C atoms; and
(b2) 0% to 30% by weight of olefinically unsaturated monomers with functional groups.

12. Adhesive bonding means according to claim 1, wherein in a vicinity of the carrier layer said adhesive bonding means additionally includes at least one further functional layer.

13. Method for using an adhesive bonding means for increasing the impact resistance of an adhesive according to claim 1, comprising the step of adding at least a low-temperature impact resistance at temperatures greater than −40° C.

14. Adhesive bonding means according to claim 4, wherein the multi-layer film is a three-layer or five-layer film.

15. Adhesive bonding means according to claim 7, wherein the density of the carrier layer is less than 0.70 g/cm³, and greater than 0.30 g/cm³.

16. Adhesive bonding means according to claim 8, wherein the particles possess an average diameter of greater than 2 pm, and not more than 12 pm.

17. Adhesive bonding means according to claim 10, wherein the pressure-sensitive adhesive layer is formed from the group consisting of acrylate adhesives, silicone adhesives, polyurethane adhesives and rubber adhesives.

18. Adhesive bonding means according to claim 6, wherein the at least one layer adjacent to the polypropylene layer is composed of polypropylene homopolymer.
